(19) United States
(12) Patent Application Publication
(10) Pub. No.: US 2026/0340479 A1
(43) Pub. Date: Oct. 29, 2026

(54) SYSTEMS AND METHODS FOR MACHINE LEARNING MODEL DEVELOPMENT

(71) Applicant: Capital One Services, LLC, McLean, VA (US)

(72) Inventors: Saurabh Annadate, Herndon, VA (US); Utkarsh Sharma, Reston, VA (US); Zhenwei Li, Glen Allen, VA (US); Suhas Alur, Henrico, VA (US); Meera Das, Vienna, VA (US); Kishore Karra, Livingston, NJ (US); Hongshuang Li, Sharon, MA (US)

(73) Assignee: Capital One Services, LLC, McLean, VA (US)

(21) Appl. No.: 19/187,395

(22) Filed: Apr. 23, 2025

(51) Int. Cl. G06N 20/00

(52) U.S. Cl. CPC G06N 20/00

(57) ABSTRACT

Methods and systems for machine learning (ML) development are disclosed. A method includes determining, by a data exploration module, at least one quality metric of a data set using at least one statistical test and/or visualization. A data processing module processes the data set based on the at least one quality metric for use by a ML model. A feature selection module determines at least one critical feature from the processed data set for building the ML model. A model selection module selects the ML model from a plurality of ML models based on the processed data set and the at least one critical feature. A model monitoring module monitors the ML model, where the monitoring includes determining whether an output of the ML model exceeds a defined threshold.

### BACKGROUND

The demand for machine learning (ML) models is rapidly expanding as new uses for ML models are found. A typical timeline for developing a ML model is nine to twelve months and involves various separate teams developing distinct stages in the ML model development. The various teams can include data scientists and non-data scientists, the latter of whom may not be well versed in the coding and testing aspects of the ML development. Also, each team may develop code in a distinct manner that results in programs that do not readily perform well with other developed programs. Having multiple code bases to do the same tasks also results in arbitrary uniqueness and increases the scope of errors.

These and other deficiencies exist. Accordingly, there is a need for a standardized framework for developing and monitoring a ML model that can also be adapted to a user's specific needs and shortens the timeline for launching a ML model.

### SUMMARY

The described subject matter relates to systems, methods, devices, and computer-readable storage mediums for ML model development. An example method for ML model development includes determining, by a data exploration module, at least one quality metric of a data set using at least one statistical test and/or at least one visualization. The method further includes processing, by a data processing module, the data set based on the at least one quality metric for use by a ML model. The method further includes determining, by a feature selection module, at least one critical feature from the processed data set for building the ML model. The method further includes selecting, by a model selection module, the ML model from a plurality of ML models based on the processed data set and the at least one critical feature. The method further includes monitoring, by a model monitoring module, the ML model, where the monitoring includes determining whether an output of the ML model exceeds a defined threshold.

In an aspect of the described subject matter, the method further includes generating, by the model monitoring module, at least one performance indicator based on output by the ML model and comparing, by the model monitoring module, the at least one performance indicator with a performance threshold.

In an aspect of the described method, after processing the data set, the data processing module automatically sends the processed data set to the feature selection module, and wherein, upon receiving the processed data set, the feature selection module automatically commences the determining at least one critical feature from the processed data set.

In an aspect of the described method, at least two modules of the data exploration module, the data processing module, the feature selection module, the model selection module, and the model monitoring module are chained such that an output from a first module of the two modules is automatically sent to a second module of the two modules, wherein the second module receives the output as input for the second module.

In an aspect of the described subject matter, the method further includes receiving, as user input, customization of at least one class, object, and/or function and calling the customized at least one class, object, and/or function based on a reference to the customized at least one class, object, and/or function in a configuration file.

In an aspect of the described method, the customized at least one class, object, and/or function comprises a customized function, wherein the customized function is automatically executed based on a reference to the customized function in the configuration file.

In an aspect of the described method, the data exploration module, the data processing module, the feature selection module, the model selection module, and the model monitoring module form a pipeline that is configured for execution by a single function call.

An example non-transitory computer-readable storage medium has stored instructions for machine learning (ML) model development that when executed by a processor cause the processor to determine at least one quality metric of a data set using at least one statistical test and/or at least one visualization. The instructions, when executed, further cause the processor to process the data set based on the at least one quality metric for use by a ML model. The instructions, when executed, further cause the processor to determine at least one critical feature from the processed data set for building the ML model. The instructions, when executed, further cause the processor to select the ML model from a plurality of ML models based on the processed data set and the at least one feature. The instructions, when executed, further cause the processor to monitor the ML model, where the monitoring includes determining whether an output of the ML model exceeds a defined threshold.

In an aspect of the described non-transitory computer-readable storage medium, after processing the data set, the instructions when executed by the processor cause the processor to generate at least one performance indicator based on output by the ML model and compare the at least one performance indicator with a performance threshold.

In an aspect of the described non-transitory computer-readable storage medium, the instructions, when executed, further cause the processor to receive a configuration file, where the configuration file indicates the data set for processing and references at least one customized object.

In an aspect of the described non-transitory computer-readable storage medium, the instructions, when executed, further cause the processor to receive, as user input, customization of at least one class, object, and/or function and call the at least one class, object, and/or function based on a reference to the customized at least one class, object, and/or function in a configuration file.

In an aspect of the described non-transitory computer-readable storage medium, the customized at least one class, object, and/or function includes a customized function, where the instructions when executed by the processor cause the processor to automatically execute the customized function based on a reference to the customized function in the configuration file.

In an aspect of the described non-transitory computer-readable storage medium, the instructions are configured for execution by a single function call.

An example system for machine learning (ML) model development includes at least one processor and at least one memory. The memory contains a framework for ML model development including a plurality of interconnectable modules each configured to receive an input, perform at least one distinct function, and generate an output based on the input, where each interconnectable module can be arranged respective to the other interconnectable modules in a ML model development pipeline.

In an aspect of the described system, the memory further contains a user space configured to receive as user input customization of at least one class, object, and/or function, wherein the framework is configured to automatically tag the at least one class, object, and/or function and embed the at least one class, object, and/or function in the ML model development pipeline.

In an aspect of the described system, the customized at least one class, object, and/or function comprises a customized function, wherein the customized function is executed in the ML model development pipeline based on a reference to the customized function in a configuration file.

In an aspect of the described system, the plurality of interconnectable modules is configured to provide a visual representation of the generated output via a document displayed on a graphical user interface.

In an aspect of the described system, the ML model development pipeline is configured for execution by a single call function.

In an aspect of the described system, two interconnectable modules of the plurality of interconnectable modules are chained such that an output from a first interconnectable module is automatically sent to a second interconnectable module, wherein the second module receives the output as input for the second module.

In an aspect of the described system, one interconnectable module of the plurality of interconnectable modules is configured for selecting a ML model, wherein the framework is configured for generating a report based on output of the ML model.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE SEVERAL VIEWS OF THE DRAWINGS

In order to facilitate a fuller understanding of the present invention, reference is now made to the attached drawings. The drawings should not be construed as limiting the present invention but are intended only to illustrate different aspects and embodiments of the invention. To easily identify the discussion of any particular element or act, the most significant digit or digits in a reference number refer to the figure number in which that element is first introduced.

FIG. 1 illustrates a system for machine learning model development according to an example embodiment.

FIG. 2 illustrates a configuration file for executing machine learning model development according to an example embodiment.

FIG. 3 illustrates an example chaining configuration of modules according to an example embodiment.

FIG. 4 illustrates an example chaining configuration of modules according to an example embodiment.

FIG. 5 is a flow chart of an example method for machine learning development according to an example embodiment.

FIG. 6 is a flow chart of an example method for machine learning development according to an example embodiment.

FIG. 7 is a block diagram of an example computing device according to an example embodiment.

### DETAILED DESCRIPTION

The following description of embodiments provides non-limiting representative examples referencing numerals to particularly describe features and teachings of different aspects of the invention. The embodiments described will be recognized as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments will be able to learn and understand the different described aspects of the invention. The description of embodiments will facilitate understanding of the invention to such an extent that other implementations, not specifically covered but within the knowledge of a person of skill in the art having read the description of embodiments, will be understood to be consistent with an application of the invention.

Furthermore, the described features, advantages, and characteristics of the embodiments may be combined in any suitable manner. A person of ordinary skill in the art will recognize that the embodiments may be practiced without one or more of the specific features or advantages of an embodiment. In other instances, additional features and advantages may be recognized in certain embodiments that may not be present in all embodiments. A person of ordinary skill in the art will understand that the described features, advantages, and characteristics of any embodiment can be interchangeably combined with the features, advantages, and characteristics of any other embodiment.

The systems and methods disclosed herein provide a standardized framework for developing and monitoring ML models that streamlines and significantly shortens the typical timeline for developing a ML model. The framework includes interconnectable modules that form a pipeline for developing and monitoring a ML model, the entirety of which can be executed by a single function call. Each module is configured for performing unique tasks in the ML model lifecycle from data set analysis for developing a ML model to monitoring a launched ML model. A module’s output can be used by the subsequent module in the pipeline as input. The standardized framework allows developers with data science and non-data science backgrounds alike to readily utilize the framework. The framework, including the modules, may be a package development in, for example, Python and is readily customizable. In some embodiments, the framework can import any customized object, class, variable value, and function developed in Python and automatically call it in the pipeline according to a keyword referencing it in a configuration file that orchestrates the pipeline process. The framework is also package agnostic and can import third-party packages for implementation in the pipeline by one or more of the modules. It should be understood by those of ordinary skill in the art that Python is merely an example programming language that may be used, and that other programming languages may be used in accordance with aspects of the present disclosure.

A data exploration module receives a data set and determines at least one quality metric of the data set using one or more statistical tests or visualizations. A data processing module, based on the quality metric, processes the data set by performing any necessary corrections or transformations to the data set. A feature selection module determines at least one critical feature from the processed data set for building the ML model, and the model selection module selects the ML model among different types of ML models based on the processed data set and the critical feature. The model monitoring module then monitors the ML model, generates reports of the ML model outputs, and can compare the outputs to defined thresholds. The modules can be arranged as desired in the pipeline or used on an individual basis to collect the output of the specific module.

The modules are not limited to the above order of execution but can be arranged in the pipeline as desired. Additionally, fewer than all the modules can be implemented in a function call. For example, one or more of the modules can be executed to collect the corresponding outputs from those modules.

As the entire pipeline or selected portions of the pipeline can be executed by a single function call, the typical oversight and involvement generally necessary by users for developing a ML model is significantly reduced. By reducing user oversight and involvement in ML model development, time and resources can be conserved and opportunities for errors can be reduced.

The framework also provides a standardized process for developing and monitoring a ML model with available default settings and enumerated options that can be readily utilized by users with limited data science or ML experience. The flexibility of the framework to utilize one module independently or chain two or more modules together in a pipeline allows users to incrementally build a ML model while clearly storing and documenting all the outputs and steps executed for building the ML model clearly in one or more reports, ensuring easy reproducibility and validation. The framework can record the user selections and default settings implemented by the modules to enable a user to reproduce the exact process or modify the process as desired with reference to previous pipeline implementations. While providing a standardized process for developing, launching, and monitoring a ML model, the framework also can also be further customized by importing third-party packages for a module to implement and by importing customized objects, classes, variable values, and functions developed in Python. The framework and standardized process can promote efficiency, streamline model creation, reduce expenditures of time and resources, and decrease errors in model configuration, development, and the analysis and incorporation of feedback.

In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

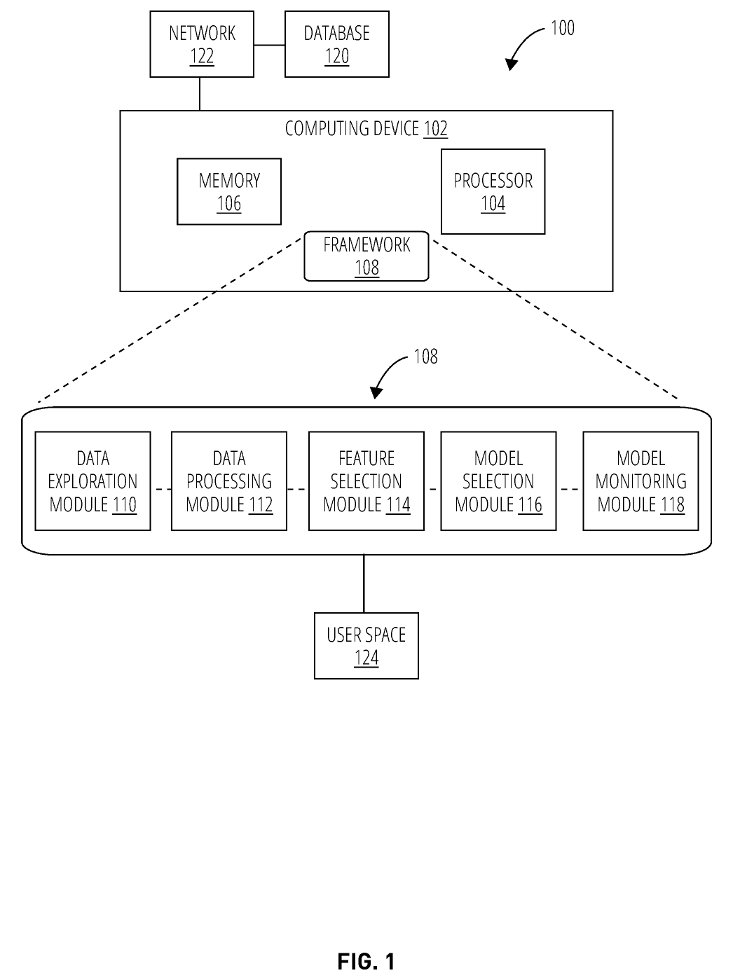

FIG. 1 illustrates a system 100 for machine learning model development. System 100 can include a computing device 102 including at least one processor 104 and memory 106. Computing device 102 can be a network-enabled computer and can be communicatively connected to a database 120. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Although only one database is shown in FIG. 1, it is understood that database 120 can include a plurality of databases. Database 120 can include at least one database accessed by computing device 102 via network 122.

Computing device 102 can execute one or more applications, such as software applications, that enable, for example, network communications with one or more components of system 100, transmit and/or receive data, and perform the functions and processes described herein. System 100 may include one or more networks 122. In some examples, network 122 may be one or more of a wireless network, a wired network or any combination of wireless network and wired network. For example, network 122 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 122 may include, without limitation, telephone lines, fiber optics, IEEE Ethernet 802.3, a wide area network, a wireless personal area network, a LAN, or a global network such as the Internet. In addition, network 122 may support an Internet network, a wireless communication network, a cellular network, or the like, or any combination thereof. Network 122 may further include one network, or any number of the exemplary types of networks mentioned above, operating as a stand-alone network or in cooperation with each other. Network 122 may utilize one or more protocols of one or more network elements to which they are communicatively coupled. Network 122 may translate to or from other protocols to one or more protocols of network devices. Although network 122 is depicted as a single network, it should be appreciated that according to one or more examples, network 122 may comprise a plurality of interconnected networks, such as, for example, the Internet, a service provider's network, a cable television network, corporate networks, such as credit card association networks, and home networks.

Computing device 102 can store locally in memory 106 and/or remotely in database 120, a framework 108 for ML model development including a data exploration module 110, data processing module 112, feature selection module 114, model selection module 116, and model monitoring module 118.

Framework 108 is a package-agnostic platform that provides a structure for utilizing the modules, namely data exploration module 110, data processing module 112, feature selection module 114, model selection module 116, and model monitoring module 118, which are also package agnostic. As framework 108 and the included modules are package-agnostic, they can readily utilize third-party packages and customized Python objects.

Within the framework 108, a user can utilize an individual module by providing at least one input to the module and receiving the resulting output from the module. A user can also create a pipeline in the framework 108 by chaining at least two of the modules together, where output from the first module is automatically sent to the second module that uses at least a portion of the received information as its own input. In the framework 108, a user can chain up to all the modules together to create a pipeline that executes an entire ML model lifeline from data set exploration and processing to ML model selection, training, and launching, to ML model monitoring. A user can also create iterations of processes within a pipeline by chaining two or more of the modules in the framework 108 to form a loop within the pipeline. A first module can be chained to multiple other modules so output of the first module is sent to each of the multiple other modules.

In a basic chaining between a first module and a second module, when the first module generates an output, the chaining causes the first module to send the output to the second module. The flexibility of framework 108 to utilize one module independently or chain two or more modules together in a pipeline allows users to incrementally build a ML model while clearly storing and documenting all the outputs and steps executed in one or more reports, as described herein. The ML model development process is generally iterative, where a user utilizes a module, manually evaluates the outputs from the module and, depending on what the user identifies as important to correct, chains one or more subsequent modules to the executed module. For example, a user may generate a report from data exploration module 110 and identify that there are outliers for one or more features. Based on the values seen in the report, the user can add data processing module 112 to the chain with a capping transformation applied to these features with identified outliers. Then the user can add another data exploration module 110 to the chain after data processing module 112 to confirm that the capping transformation solved the outlier problem. If solved, the user may continue to add subsequent modules, such as feature selection module 114, to the chain in framework 108. As described in this example, any of the modules can be added more than once to a chain where the same module appears multiple times in the same chain. Framework 108 can generate a report with details of all the steps performed to build the ML model to ensure reproducibility and easy validation by external stakeholders.

Chains can be conditional where they are only triggered by an event or a plurality of events. For example, a first module can be chained to a subsequent module and also looped to a preceding module. The loop can be triggered when the first module performs a certain process or when an output exceeds a threshold, causing the first module to send its output to the preceding module. The looping being triggered can also cause the chain to the subsequent module to not be triggered despite the first module generating an output. As a result, the first module sends its output to the preceding module but not to the subsequent module. When the loop is not triggered because the first module does not perform a specific process or the output does not exceed a threshold value, the first module sends the output to the subsequent module and not the preceding module. Chaining can also be configured to cause a first module to send something instead of or in addition to its output to a second module, such as instructions to perform a process.

For example, as further described herein, data exploration module 110 generates quality metrics of a data set and data processing module 112 transforms or corrects the data set as needed. In the framework 108, a user can chain data exploration module 110 to data processing module 112 so that the quality metrics generated by data exploration module 110 are sent to data processing module 112, which then transforms or corrects the data set as needed based on the received quality metrics. A user can also loop data processing module 112 back to data exploration module 110 so that the processed data set outputted by data processing module 112 is sent to data exploration module 110. Data exploration module 110 then generates new quality metrics for the processed data set and sends the updated quality metrics to data processing module 112. Based on the updated quality metrics, data processing module 112 further transforms or corrects the data set as needed. This loop can continue until data processing module 112 determines, based on the most recently received quality metrics, that no further processing of the data set is required. As framework 108 enables a user to create the pipelines and loops, the user does not need to supervise or intervene after each process within the pipeline. It is understood that instead of looping modules with triggers, a user can add the same module in multiple places in a chain. For example, a user may chain data exploration module 110 to data processing module 112 to another data exploration module 110.

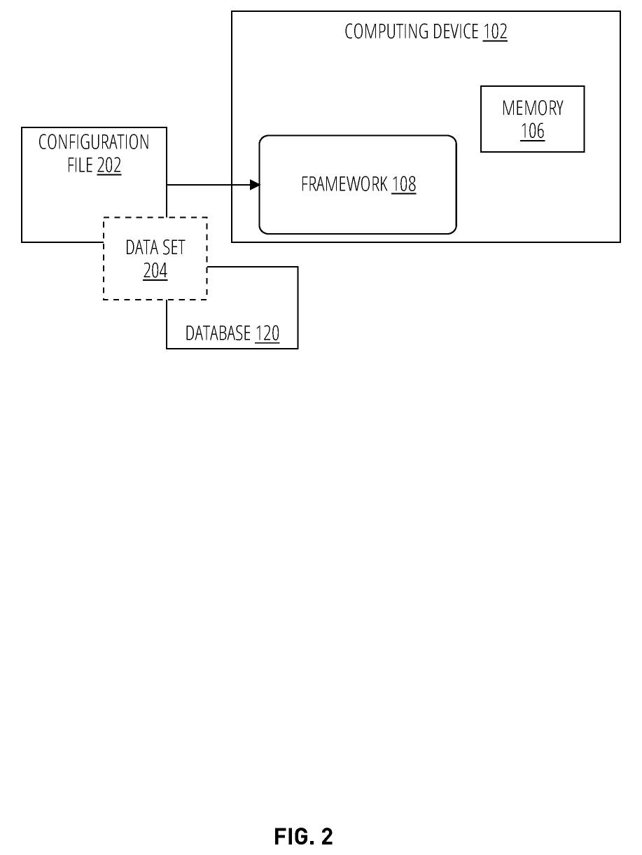

Framework 108 can receive instructions from a user by a configuration file, such as the configuration file 202 shown in FIG. 2. Configuration file 202 can use a module separately, organize the modules within the framework by chaining and looping modules, define settings for the modules, call third-party packages for a module to implement, call customized Python objects for utilization in the pipeline, and upload or call a selected data set for use in the pipeline.

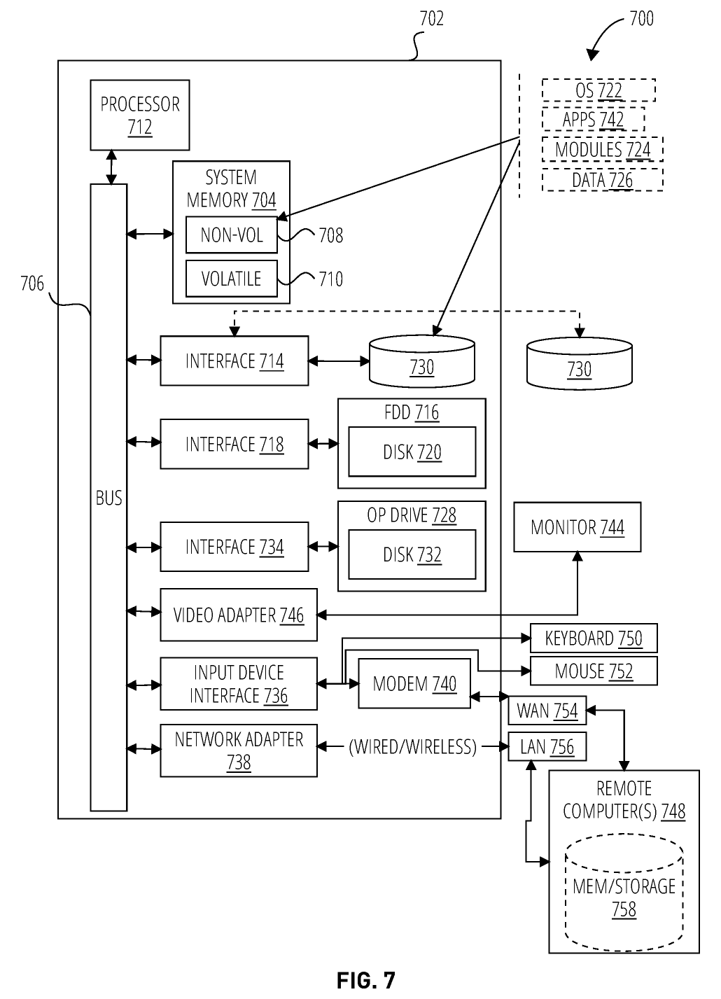

Referring again to FIG. 1, data exploration module 110, data processing module 112, feature selection module 114, model selection module 116, and model monitoring module 118 can be interconnected and form a pipeline for the development and eventual monitoring of a ML model. The entire pipeline can be executed by a single function call. Each module can be used independently, in combination of two or more modules, or all the modules as a pipeline from data exploration module 110 to model monitoring module 118. A user can enter commands and other user input into computing device 102 through one or more wire/wireless input devices, for example, a keyboard 750 and a pointing device, such as a mouse 752 as shown in FIG. 7.

Data exploration module 110 performs exploratory data analysis of a data set and can generate data quality metrics using one or more statistical tests and/or visualizations. Data exploration module 110 receives a data set, which can be input by a user for the current task or stored and retrieved from a data set library. It is understood that use of the term “library” refers to categorized or otherwise organized data stored in memory 106 and/or database 120. The data set can be real data harvested, fabricated data, or a combination thereof. Data exploration module 110 can be communicatively connected to statistical tests stored in a statistical test library from which the data exploration module 110 can implement on a data set to determine quality metrics. The statistical tests can include tests that determine one or more data quality metrics from the data set, such as a minimum value, maximum value, mean, mode, standard deviation, distribution, variance, percentage of data values in a category or range, and the like. System 100 can include the statistical tests and data exploration module 110 can import and utilize third-party statistical tool packages for determining the quality metrics, which provides a user the flexibility of using statistical tests that may not be included in data exploration module 110. Data exploration module 110 can determine difference categories, ranges, or features within the data set and associate the data within the data set with the corresponding categories, ranges, and features. In some embodiments, data exploration module 110 can receive, as user input, defined categories, ranges, and features. Data exploration module 110 can provide the quality metrics per each category, range, or feature as well as the quality metrics overall for the whole data set. In some embodiments, data exploration module 110 can provide a comparison of the quality metrics among the different categories, ranges, and features.

Data exploration module 110 can generate quality metrics of the data set using one or more visualizations. A visualization is a visual representation, such as a graphical representation, of one or more ML models, data distributions, and their relationships. Nonlimiting examples of visualizations can include bar charts, scatter plots, histograms, and heatmaps.

Data exploration module 110 can identify and flag issues in the data set that may effect the data set's viability for being used for ML model development, such as a zero value, infinity value, and nonvalue. Data exploration module 110 can provide a percentage of the data set that contains each issue type and/or any of the identified issues. Issues in the data set can also include imbalanced data. For example, in a ML model for categorizing data where at least one of the categories is significantly underrepresented in the data set, the data set may not be adequate for developing the ML model in recognizing data that should associated with one of the underrepresented categories. This issue can arise when a category seldomly occurs in real life compared to other categories and especially can be an issue when the ML model is being developed to identify an event that seldomly occurs. For example, framework 108 can be used to develop a ML model that identifies fraudulent transactions or money laundering. If the data set includes data gathered from real transactions, the instances of fraudulent transactions among all the transactions will be underrepresented because fraud seldomly occurs among all transactions. In this example, the data set may have imbalanced outcomes, namely nearly all outcomes being legitimate transactions, which can lead to issues in developing a ML model to identify a fraudulent transaction or money laundering.

The foregoing disclosure of the development of a ML model to identify fraudulent transactions or money laundering is exemplary. It is understood that the present application is not limited thereto and encompasses the development of ML models used for any purpose.

Data exploration module 110 can generate and display on a graphical user interface (GUI), such as monitor 744 shown in FIG. 7, a visual representation of the determined quality metrics using a visualization package. The visualization package can be used by data exploration module 110 with or without configuration by the user. In some embodiments, data exploration module 110 can receive user input to customize the visualization. Customization of visual representations of outputs of any modules described herein, such as the visual representation of the determined quality metrics, can include a selection of which outputs and other information are visualized and the manner in which the outputs are displayed, for example by list, graph, and pie chart. As framework 108, including data exploration module 110, is package agnostic, the visualization package implemented by the data exploration module 110 can be an imported third-party visualization package. Data exploration module 110 can import and implement any visualization package know in the art including, for example, Matplotlib and Seaborn.

Data processing module 112 receives the data set and determined quality metrics and identified issues from data exploration module 110. Based on the determined quality metrics and/or identified issues in the data set, the data set may require one or more corrections and/or transformations, which data processing module 112 can perform on the data set. Transformations applied to the data set can include, without limitation, log transformations, square root transformations, scalers, and binning. For example, log transformations apply a logarithmic function to the data set, which compress the range of values and reduce the impact of outlier values.

In examples where imbalanced outcomes in the data set is an identified issue, data processing module 112 can import at least a portion of data from one or more other data sets and combine the data with the current data set to balance the data set. Data processing module 112 can also perform sampling of the data to balance the imbalanced outcomes. The other data sets can be data sets in a data set library or additional data sets imported by a user. The one or more other data sets can be identified as backup data sets by the user in case additional data is determined necessary by data processing module 112. For example, when a user initially identifies the data set for data exploration module 110, the user may further identify one or more backup data sets from which data processing module 112 can pull additional data. The user may rank the one or more other data sets for use according to the order in which data processing module 112 should use the other data sets. In some embodiments, data processing module 112 can analyze the other data sets to identify data of underrepresented outcomes and import largely or exclusively the data with the underrepresented outcomes. In some embodiments, the data exploration module 110 has already determined the quality metrics of the other data sets and data processing module 112 imports data from the other data sets based on their corresponding quality metrics. The data set that has been analyzed by data processing module 112 and corrected and/or transformed as needed is now processed. Data processing module 112 can send the processed data to feature selection modules 114.

When data processing module 112 corrects or transforms the data set, instead of sending the processed data directly to feature selection module 114, the data processing module 112 can send the processed data set back to data exploration module 110 to determine the quality metrics and identify any issues of the processed data. If issues are still identified in the processed data, data exploration module 110 can return the processed data to data processing module 112 with the quality metrics and identified issues, and data processing module 112 can determine if further correction or transformation of the processed data is required. If data processing module 112 further processes the data, then data processing module 112 can return the updated processed data set to data exploration module 110 to determine updated quality metrics and/or issues of the processed data set. The repeated steps of processing the data set by data processing modules 112, determining quality metrics and issues of the processed data set by data exploration module 110, and sending the quality metrics and identified issues to data processing module 112 can continue until data exploration module 110 determines there are no more issues with the processed data set or data processing module 112 determines that no further processing of the data set is needed, at which point data exploration module 110 or data processing module 112 can send the processed data set to feature selection module 114.

Feature selection module 114 receives a data set and determines critical features in the data set. The data set can be sent from data exploration module 110 or data processing module 112 or directly imported by a user. Feature selection module 114 determines critical features in the processed data set for use in developing the ML model. Feature selection module 114 can pull from a library of methodologies to determine critical features in the data set. Feature selection module 114 can include a preselected or default methodology and automatically use the methodology to determine the critical features or receive user input selecting a methodology for feature selection module 114 to use. The critical features are features or variables whose values have a statistically significant correlation to the outcome, which is the output of the ML model. For example, critical features for a ML model for identifying money laundering could include the number of transactions during a defined time period, a total monetary amount for transactions involving any individuals and business entities associated with a specific individual or business entity, and the number of financial accounts associated with the specific individual or business entity. The critical features could include the merchant category of parties involved in the transactions, such as retail, groceries, entertainment, jewelry, and services where goods are not transferred. The critical features could also include the size of the parties involved in the transaction, such as the annual revenue of the party, the number of employees, whether the party is a franchise, and whether the party has multiple locations.

Determining which features or variables are critical features (and which features or variables are not critical) is crucial for developing a ML model that can accurately determine outcomes. If features or variables are selected as critical features that do not have a strong correlation to the outcome or are otherwise erratic in their correlation to the outcome, then developing a ML model based on those critical features will result in a ML model with a compromised performance. It is understood that correlations can include inverse correlations. For example, a variable that has a strong inverse correlation to the outcome has a strong correlations to the outcome.

Feature selection module 114 can identify the features and variables in the data set and determine their correlation strength to the outcome. In some embodiments, feature selection module 114 can automatically select the one or more critical features by selecting the one, two, three, or any defined number of features with the greatest statistical correlations to the outcome. In some embodiments, feature selection module 114 can list in ascending or descending order of the identified features and variables by their corresponding correlation strength and receive user input selecting the critical features. The critical features can be used for selecting a type of ML model, adjusting parameters in the ML model, training the ML model, and/or validating the trained ML model. Feature selection module 114 can present the critical features on a GUI.

Model selection module 116 evaluates different ML model constructs and selects a ML model among the different ML models. The ML model constructs can include different types of ML models such as, without limitation, linear regression, logistic regression, random forest, decision tree, clustering, and neural network and several different combinations of hyperparameters for the same. Model selection module 116 can select a ML model based on the data set, such as the data set processed by data processing module 112, and the critical features determined by feature selection module 114. For example, model selection module 116 can select the ML model based on characteristics of the data set and/or the critical features compared to general attributes, weaknesses, and strengths of the different ML models types. For example, if feature selection module 114 determines only one or two critical features, model selection module 116 may select a linear regression ML model that can receive training data to associate the values of the one or two critical features with the corresponding outcomes. If feature selection module 114 does not identify any features with a strong correlation to the outcome but instead determines numerous features with low correlations to the outcome, model selection module 116 may select a clustering ML model that is better suited than other ML models for determining outcomes when there are not strong critical features. If feature selection module 114 selects numerous critical features with medium to strong correlations with the outcome, model selection modules 116 may select a decision tree ML model, which may be better suited than a linear regression ML model for data with many critical features. Model selection modules 116 can also select a combination of ML models, for example one or more supervised learning ML models in a neural network. Model selection modules 116 can receive, as user input, adjustments to parameters and hyperparameters of the selected ML model, which model selection module 116 can log. Model selection module 116 can also train the selected ML model using at least a portion of the processed data set and/or other imported data sets. Model selection module 116 can further validate the trained ML model using at least a portion of the processed data set and/or other imported data sets, which may be distinct from the data used for training the ML model to avoid false confidence in the performance of the ML model. For validation, model selection module 116 can implement the monitoring performed by model monitoring module 118 to monitor the ML model as described below. In some embodiments, model monitoring module 118, instead of model selection module 116, can validate the trained ML model in the same manner it performs ongoing monitoring of the ML model.

Model monitoring module 118 can monitor the performance of the ML model after the ML model has launched and is receiving real and new data. Validating and/or monitoring the ML model can include generating at least one performance indicator based on the output of the ML model. Performance indicators can include, for example, accuracy, precision, specificity, confusion matrix, recall, F1-score, Receiver Operating Characteristic (ROC) curve, and Area Under the Receiver Operating Characteristic (AUC-ROC) curve. Performance indicators can indicate the percentage of true positives, false positives, true negatives, false negatives, or otherwise incorrect classifications among the total ML model output. Model monitoring module 118 can compare the performance indicators with corresponding defined thresholds, which may be default thresholds or customized by user input, and flag any performance indicators that exceed the corresponding threshold.

Model monitoring module 118 can generate a report of the ML model performance including outputs or artifacts of the ML model, a comparison of the outputs to the defined thresholds. The report can include a log of packages used for the development and monitoring of the ML model including identification of the version and author of the packages, the one or more data sets used and how they were used, the quality metrics and identified issues in the data set.

Framework’s 108 model development process, namely implementation of data exploration module 110, data processing module 112, feature selection module 114, and/or model selection module 116, can generate a report that can easily be shared with stakeholders and can be version controlled via, for example, GitHUB. The report can include a log of packages used for the development and monitoring of the ML model including identification of the version and author of the packages, the one or more data sets used and how they were used, the quality metrics and identified issues in the data set, the steps performed by data processing module 112 for processing the data set, the determined critical features and their correlation strengths, the model type of the selected ML model, adjustments of parameters and hyperparameters, and/or any other user input. The report can provide sufficient detail for a user to reproduce the entire ML model development or any sub-component of the pipeline. Model monitoring module 118 can include in the report outputs from any of the modules within the pipeline according to received user instructions. The report can be a document displayed on a graphical user interface. The report can be in various formats including HTML or PDF.

If model monitoring module 118 flags any performance metrics that exceed thresholds, a user can then evaluate whether to adjust parameters or hyperparameters or select a different type of ML model in model selection module 116, change the selected critical features in feature selection modules 114, or even use a different data in data exploration modules 110 and start at the beginning of the pipeline.

Framework 108 can include a user space 124, which enables customizability of the modules and the pipeline. User space 124 is an entry point for a user to input any customized component in the framework 108. For example a user can create any Python object, class, variable value, function, and summation and utilize user space 124 to pass it to framework 108. The description focuses primarily on customized Python objects, but it is understood that, unless otherwise specified, description of Python object also applies to any Python class, variable value, function, and summation. User space 124 can include an anchor or act as an anchor to pick up the customized Python object, which the framework 108 can then call. The user space 124 can catch any Python object by referencing a keyword associated with the Python object in a configuration file. The framework 108 can also pull out Python objects from the models that any of the models utilize, which can then be exported for use in another context.

It is understood that stored information implemented by framework 108 or any of the modules described herein can be stored remotely and/or locally in memory, such as in one or more servers or databases. The stored information can include, without limitation, any tests implemented by one or more modules, such as statistical tests used by the data exploration module 110; data sets; processed data sets that have been processed by the data processing module 112 or imported as pre-processed data sets, defined thresholds; standardized and customized Python classes, objects, and functions; machine learning models. The stored information can be organized in at least one library where each library stored a specific one or more categories of information or information specific to a module. For example, one stored library can include a library of statistical tests from which the data exploration module 110 can implement on a data set to determine quality metrics.

FIG. 2 illustrates a configuration file 202 for executing machine learning model development. Framework 108 in computing device 102 receives configuration file 202, which includes instructions for executing at least one of the modules in framework 108, as shown in FIG. 1. Configuration file 202 includes at least one function call to execute the ML model development process. The configuration file can execute the entire ML model development process, as described in reference to FIG. 1, with a single function call. Configuration file 202 can also selectively execute fewer than all the steps in the entire ML model development process and use fewer than all the modules. Configuration file 202 can dictate the order in which steps are performed in the ML model development process and can define a specific order of the steps and modules within the pipeline to be executed.

Configuration file 202 can identify one or more data sets 204 in a data set library stored in database 120 or memory 106 and/or configuration file 202 can include at least one data set 204 for data exploration module 110 to determine quality metrics and identify issues, for data exploration module 110 to process, and/or for training and/or validation by model selection module 116 or model selection module 116. Configuration file 202 can include at least one of hyperparameter adjustments and parameter adjustments for model selection module 116 to make with the ML model, a ML model type selection, and the number of critical features for feature selection module 114 to select. Configuration file 202 can identify which outputs and other metrics to include in a generated report or to display on a GUI.

Framework 108 can receive and call a customization of at least one class, object, variable value, and/or function based on a reference to the customized class, object, and/or function. Framework 108 and the corresponding module can automatically execute a customized function based on a reference to the customized function in configuration file 202. Configuration file 202 can include at least one keyword referencing a customized Python object. Referencing the keyword of a customized Python object in configuration file 202 calls the customized object. The keyword can be referenced in configuration file 202 at a placement in relation to functions within the pipeline according to when a user wants to call the customized object. Similarly, framework 108 can export any of the Python objects in configuration file 202. Specifically, framework 108 can receive a user instruction in configuration file 202 or via another user input to export a selected Python object that is used in framework 108 and export the selected object.

Framework 108 can log and generate a report including any outputs by modules such as quality metrics, processed data sets indicating the changes made to the original data set, correlation strengths of features and variables, the ML model selected, and outputs or artifacts by the ML model and performance indicators based on the outputs by the ML model at the training, validation, and monitoring phases. The log and report can include an identifier of the data set used; all settings for the modules including any default settings or input settings; parameters and hyperparameters for the ML model; identifiers of the tools and packages implemented by any modules and their corresponding inputs, settings, and outputs; the pipeline configuration including any chaining and conditions to the chaining; any customized Python objects implemented and how they were implemented; configuration file 202; and any other user inputs.

Framework 108 can generate a report after each pipeline execution. As described herein, the modules can be implemented independently or in combination with one or more other modules as part of a pipeline chain. For example, if a pipeline includes only one module, then the generated report can include the output logs from that module. If a pipeline includes multiple modules, then after the pipeline is executed, framework 108 can generate a report including output logs from the multiple modules. In some embodiments, framework 108 can generate a separate report for each module after each iteration of outputs by the module. The report can compare outputs or other indicators used by the modules, such as correlation strengths of the features and variables and performance indicators for the ML model output, to defined thresholds as described herein. The information logged and the reports can be exported for use in analyzing performance of the ML model. For example, framework 108 can export the logged information and generated reports for a user to send to an analyzing tool to further anaylze the performance of the ML model. Framework 108 can store all the intermediate and final artifacts, such as summary tables, visualization, model object, etc., in the file system, which can be stored locally and/or remotely. The file system can then be used for downstream purposes or shared with stakeholders. Configuration file 202 and reports can be version controlled via version control system in framework 108, for example Git, and can be shared with others to consume or reproduce the analysis. Framework 108 can also log package configuration versions in the report, which allows a user to easily track the development of the ML models and determine which versions or commit hashes were used.

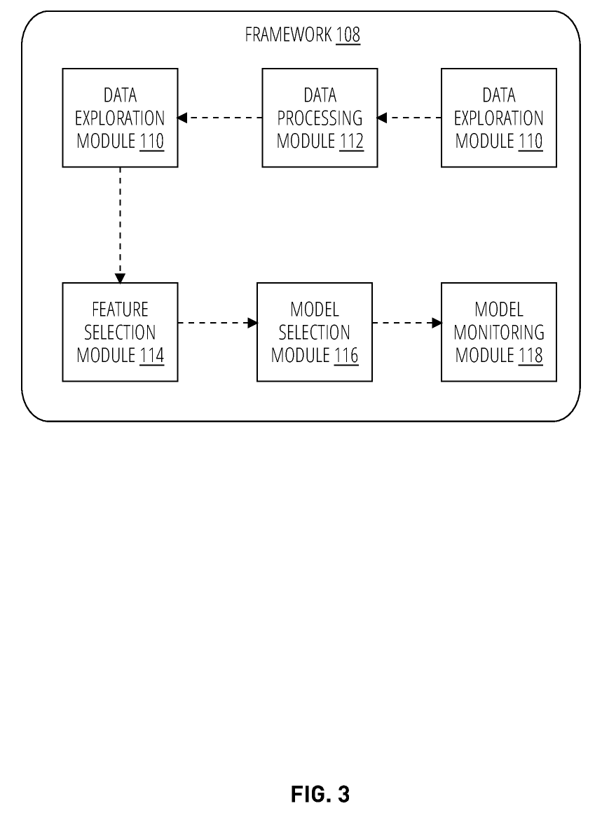

FIG. 3 illustrates an example chaining configuration of modules in framework 108. The modules are chained together to execute a complete process of developing a ML model from data exploration module 110 to model selection module 116. After the ML model is built and launched, a user can implement model monitoring module 118 to monitor the ML model. Although model monitoring module 118 is shown in FIG. 3 as part of the chain, a user may utilize the model monitoring module 118 separately after the ML model is built. As shown in FIG. 3, the pipeline in framework 108 includes data exploration module 110 in two locations, where the data exploration module 110 is directly before and after data processing module 112.

In an example use of framework 108, a user may initially chain only data exploration module 110 to data processing module 112. Data exploration module 110 receives or calls a data set and generates at least one quality metric of the data set by using at least one statistical test or visualizations. The quality metrics can include flagged issues in the data set. Data exploration module 110 is chained to data processing module 112, causing data exploration module 110 to send the outputted quality metrics to data processing module 112. Data processing module 112 uses the received quality metrics to determine whether the data set requires transforming and/or correcting. For example, data processing module 112 can determine whether the data set requires processing by comparing the received quality metrics to threshold quality metrics, which may each be associated with one or more specific transformations or corrections to the data set if the corresponding threshold is exceeded. Data processing module 112 can then perform the requisite transformations and/or corrections to the data set. Transformations applied to the data set can include, without limitation, log transformations, square root transformations, scalers, and binning. For example, if a quality metric exceeds a threshold indicating that the data set has values too far from each other, the quality metric can be associated with a specific transformation, such as a log transformation, which applies a logarithmic function to the data set that compresses the range of values and reduces the impact of outlier values. Data processing module 112 then performs the log transformation on the data set.

As another example, the quality metrics may exceed one or more thresholds that indicate an imbalance in the data set, namely an underrepresentation of at least one type of outcome. In examples where imbalanced outcomes in the data set is an identified issue, data processing module 112 can import at least a portion of data from one or more other data sets and combine the data with the current data set to balance the data set as described herein. Data processing module 112 can also perform sampling of the data to balance the imbalanced outcomes.

Framework 108 can generate a report detailing the configuration of each module in the chain, such as the version of the module and their settings, as well as their outputs. If data processing module 112 performs any process on the data set, such as a transformation or correction to the data set, a user may want to send the processed data set through data exploration module 110 to identify the quality metrics and any flagged issues of the processed data set. The user can chain data processing module 112 to another data exploration module 110 to create a chain that includes data exploration module 110 to data processing module 112 to another data exploration module 110, causing the data processing module 112 to send its output, namely the processed data set, to the another data exploration module 110 to determine the quality metrics and flag any issues of the processed data set. Framework 108 can generate a report including the output from the three modules in the chain. If a user determines that further data processing is required, the user can chain additional modules of data processing module 112 and/or data exploration module 110, for example a chain that now includes a first data exploration module 110 to a first data processing module 112 to a second data exploration module 110 to a second data processing module 112, and so on until the user is satisfied that the data set requires no further processing. If a user determines that no further processing is required, the user can then chain the last module, which is likely the last data exploration module 110, to feature selection module 114. Chaining the last module, either data exploration module 110 or data processing module 112, to feature selection module 114 causes the last module to send the processed data set to the feature selection module 114.

Feature selection module 114 determines at least one critical feature from the received processed data set. A user can review the generated report and, if satisfied with the determined at least one critical feature, chain features selection module 114 to model selection module 116, which causes the features selection module 114 to sends the outputted determined at least one critical feature to model selection module 116. Model selection module 116 selects a model among a plurality of ML models based on the at least one critical feature received from feature selection module 114. Feature selection module 114 can also training and/or validate the selected ML model. The ML model is now ready to be launched and use real data. This concludes the ML model process pipeline. A user can separately utilize model monitoring module 118 to monitor the launched ML model. Model monitoring module 118 monitors the ML model and determines whether an output of the ML model exceeds a defined performance threshold. Alternatively, a user can chain feature selection module 114 to model selection module 116 for the model selection module 116 to automatically send the ML model to the model monitoring module 118 for monitoring. . In some embodiments, either model selection module 116 or model monitoring module 118 can launch the ML model where the model receives real data. For each execution of a separate module or a pipeline with multiple chained modules, framework 108 can document and store all the steps performs and the corresponding outputs for reproducibility and validation by other users.

Alternatively, instead of including data exploration module 110 in multiple locations in the chain, a user can include a loop in the pipeline to iteratively process a data set until quality metrics of the data set indicate that no further processing is needed. The module configuration can include a loop from data processing module 112 to data exploration module 110, and data processing module 112 can also be chained to feature selection module 114. This module configuration in framework 108 instructs data processing module 112, in the event that data processing module 112 performs any process on the data set such as a transformation or correction to the data set, data processing module 112 sends the processed data set to data exploration module 110 to determine the quality metrics of the processed data set. Otherwise, data processing module 112 sends the data set to feature selection module 114.

Each time data exploration module 110 receives a data set, such as the processed data set from data processing module 112, data exploration module 110 generates quality metrics for the received data set and sends the quality metrics to data processing module 112. Data processing module 112 then determines whether further processing, such as additional transformations and/or corrections, is required for data set and performs the processing accordingly. As noted above, if data processing module 112 further processes the data set, then data processing module 112 sends the updated data set back to data exploration module 110 to again generate and return quality metrics. This loop continues until data processing module 112 determines, based on the most recently received quality metrics, that no further processing of the data set is required.

When data processing module 112 does not further process the data set during this iteration, then the loop is no longer triggered and data processing module 112 sends the data set to feature selection module 114.

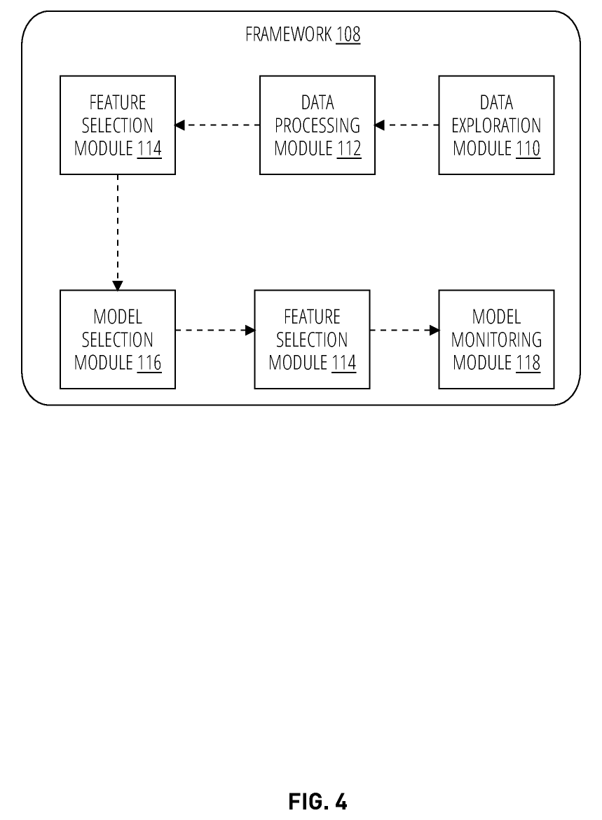

FIG. 4 illustrates another example chaining configuration of modules in framework 108. Although model monitoring module 118 is shown in FIG. 4 as part of the chain, a user may utilize the model monitoring module 118 separately after the ML model is built. As shown in FIG. 4, the pipeline in framework 108 includes feature selection module 114 in two locations, where the features selection module 114 is directly before and after model selection module 116.

In an example use of framework 108, a user may chain data exploration module 110 to data processing module 112 to feature selection module 114 to model selection module 116, incrementally chaining an additional module after reviewing the report for the corresponding current pipeline.

Data exploration module 110 generates at least one quality metric of a data set and sends the at least one quality metric to data processing module 112. Data processing module 112 determines whether processing the data set is required based on the quality metrics received and performs at least one transformation and/or correction to the data set as it determines is necessary. The data processing module 112 sends the processed data set to feature selection module 114, which determines at least one critical feature from the processed data set.

Feature selection module 114 can identify the features and variables in the data set and determine their correlation strength to the outcome. In some embodiments, feature selection module 114 can automatically select the one or more critical features by selecting the one, two, three, or any defined number of features with the greatest statistical correlations to the outcome. The critical features can be used for selecting a type of ML model, adjusting parameters in the ML model, training the ML model, and/or validating the trained ML model. Feature selection module 114 is chained to model selection module 116 and sends the critical features to model selection module 116.

Model selection module 116 evaluates different ML model constructs and selects a ML model among the different ML models and different model configurations. The ML model constructs can include different types of ML models such as, without limitation, linear regression, logistic regression, random forest, decision tree, clustering, neural network, and several different combinations of hyperparameters for the same. Model selection module 116 can select a ML model based on the data set, such as the data set processed by data processing module 112, and the critical features determined by feature selection module 114. For example, model selection module 116 can select the ML model based on characteristics of the data set and/or the critical features compared to general attributes, weaknesses, and strengths of the different ML models types. For example, if feature selection module 114 determines only one or two critical features, model selection module 116 may select a linear regression ML model that can receive training data to associate the values of the one or two critical features with the corresponding outcomes. If feature selection module 114 does not identify any features with a strong correlation to the outcome but instead determines numerous features with low correlations to the outcome, model selection module 116 may select a clustering ML model that is better suited than other ML models for determining outcomes when there are not strong critical features. If feature selection module 114 selects numerous critical features with medium to strong correlations with the outcome, model selection modules 116 may select a decision tree ML model, which may be better suited than a linear regression ML model for data with many critical features. Model selection modules 116 can also select a combination of ML models, for example one or more supervised learning ML models in a neural network.

Model selection module 116 can train the selected ML model using at least a portion of the processed data set and/or other imported data sets. Model selection module 116 can further validate the trained ML model using at least a portion of the processed data set and/or other imported data sets, which may be distinct from the data used for training the ML model to avoid false confidence in the performance of the ML model. For validation, model selection module 116 can implement the monitoring performed by model monitoring module 118 to monitor the ML model.

Model selection module 116 can determine at least one performance indicator based on the output of the ML model. Performance indicators can include, for example, accuracy, precision, specificity, confusion matrix, recall, F1-score, ROC curve, and AUC-ROC curve. Performance indicators can indicate the percentage of true positives, false positives, true negatives, false negatives, or otherwise incorrect classifications among the total ML model output. Model selection module 116 can compare the performance indicators with corresponding defined thresholds, which may be default thresholds or customized by user input, and flag any performance indicators that exceed the corresponding threshold. The performance thresholds for training and validating may be different than the performance thresholds for monitoring the ML model after it is launched.

Framework 108 can generate a report of an executed pipeline including data exploration module 110 through model selection module 116. If a user determines from the report that the ML model is not performing adequately during the training or validation by the model selection module 116, for example if the ML model performance exceeds a threshold performance, the user can chain model selection module 116 to another feature selection module 114 to re-select the critical features. A user can include in the pipeline instructions to the second features selection module 114 regarding the process of selecting the critical features, such as increasing or decreasing the number of critical features that should be selected or only selecting features or variables with correlations to the outcome that exceed a threshold level. The second feature selection module 114 can re-select the critical features according to the instructions. Framework 108 can generate an updated report including the selected critical features by the second feature selection module 114. If the user determines that the selected critical features are adequate, the user can chain the second feature selection module 114 to a second model selection module 116, causing the second feature selection module 114 to send the selected critical features to the second model selection module 116.

Using the critical features from the second feature selection module 114, the second model selection module 116 selects a ML model among the different ML models. Model selection module 116 proceeds to training and validating the ML model, using the same data as used for the previous ML model by the first model selection module 116 or the second model selection module 116 can use different data. Model selection module 116 uses outputs of the ML model to determine performance indicators that it compares to one or more performance threshold. A user can adjust instructions for model selection module 116 to stop the pipeline and have framework 108 generate a report before validation. If performance indicators do not exceed performance thresholds during training, a user can instruction model selection module 116 to proceed with validating the ML model.

If the second model selection module 116 selects a ML model that is not performing adequately during the training or validation, then the user can chain the second model selection module 116 to a third feature selection module 114, and so on, until performance indicators of the ML model indicate that the model is performing adequately. After the ML model has been trained and validated, the ML can be launched. Model monitoring module 118 can be chained to the last module in the pipeline, which is likely the last model selection module 116, or used separately from the pipeline to monitor the launched ML model.

Instead of including feature selection module 114 and model selection module 116 in multiple locations in the chain, a user can include a loop in the pipeline to iteratively test a selected ML model and adjust selected critical features until the ML model’s performance indicates that the ML model is adequate. Model selection module 116 can be looped to feature selection module 114 and can also be chained to model monitoring module 118. The loop can be triggered if the ML model is not adequately performing during the training or validation process. If the ML model is adequately performing during the training, then model selection module 116 proceeds to validating the ML model. When the loop is triggered, model selection module 116 does not send its output model monitoring module 118. The loop can be triggered if the ML model's performance exceeds a threshold performance. If the performance indicators exceed a performance threshold, the loop is triggered and model selection module 116 instructs feature selection module 114 to re-select critical features. The instructions can include the performance indicators. The instructions can includes detailed instructions regarding the process of selecting the critical features, such as increasing or decreasing the number of critical features that should be selected or only selecting features or variables with correlations to the outcome that exceed a threshold level. Feature selection module 114 re-selects the critical features according to the instructions and sends the critical features to model selection module 116. Using the updated critical features, model selection module 116 selects a ML model among the different ML models. Model selection module 116 proceeds to training and validating the ML model, using the same data as used for the previous ML model or model selection module 116 can use different data. Model selection module 116 uses outputs of the ML model to determine performance indicators that it compares to one or more performance threshold. If performance indicators do not exceed performance thresholds during training, model selection module 116 proceeds to validate the ML model. If performance indicators exceed performance thresholds during the training or validation, then the loop is again triggered and model selection module 116 sends instructions to feature selection module 114 to re-select critical features. The instructions can be different that the previous instructions. For example, each iteration when the loop is triggered, the instructions can further increase or decrease the number of critical features to be selected and/or increase the threshold correlation strength the features or variable must exceed for selection. The loop continues until the performance indicators do not exceed any performance threshold at the training or validation phase, at which point model selection module 116 sends the trained and validated ML model to model monitoring module 118.

In some embodiments, the loop may have further triggering conditions. For example, if a performance indicator exceeds a performance threshold, model selection module 116 may first determine whether a different ML model type than the one selected is a strong candidate based on the data set and/or the critical features. If model selection module 116 determines that there is a strong candidate, then model selection module 116 can proceed to train and validate the alternate ML model instead of immediately triggering the loop. In this example, the loop is only triggered if model selection module 116 determines there is not a different ML model that is a strong candidate or a performance indicator of the alternate ML model exceeds a performance threshold during the training or validation phase.

In some embodiments, model monitoring module 118 can loop to feature selection module 114 based on output of the ML model. For example, model monitoring module 118 can determine at least one performance indicator based on the output of the ML model. If one or more performance indicators exceeds a performance threshold, this can trigger model monitoring module 118 instructing feature selection module 114 to select different critical features. The instruction can include detailed instructions such as increasing or decreasing the number of critical features or only selecting critical features with correlations to the outcome that exceed a threshold level.

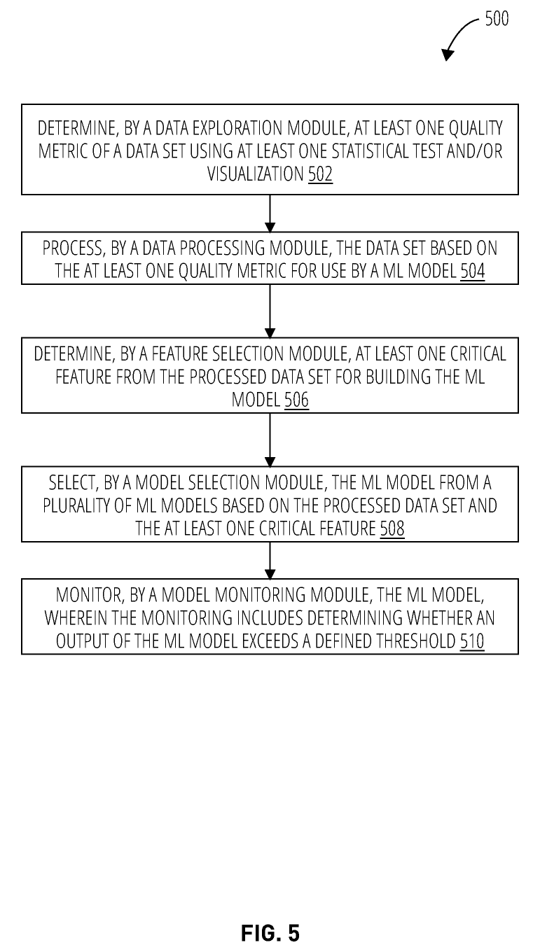

FIG. 5 is a flow chart of an example method 500 for machine learning development. In block 502, a data exploration module determines at least one quality metric of a data set using at least one statistical test and/or visualization. The data set can be input by a user for the current task or it can be stored and retrieved from a data set library. The data set can be real data harvested, fabricated data, or a combination thereof. One or more statistical tests can be provided by the data exploration module and a user can import additional statistical tests for the data exploration module to implement. Quality metrics can include, for example, a minimum value, maximum value, mean, mode, standard deviation, distribution, variance, percentage of data values in a category or range, and the like. The data exploration module can also identify and flag issues in the data set that may affect the data set's viability for use in the development of the ML model, such as such as a zero value, infinity value, nonvalue, and an imbalanced data set with one or more categories that are significantly underrepresented. The data exploration module can generate and display the determined quality metrics and flagged issues on a GUI and can generate a report including the same.

In block 504, a data processing module processes the data set based on the at least one quality metric for use by a ML model. The data processing module may determine, based on the received quality metrics, including any flagged issues, that the data set requires one or more corrections and/or transformations, which the data processing module then performs on the data set. Transformations can include, for example, log transformations, square root transformations, scalers, and binning. In examples where imbalanced outcomes in the data set is an identified issue, the data processing module can import at least a portion of data from one or more other data sets and combine the data with the current data set to balance the data set. The data processing module can also perform sampling of the data to balance the imbalanced outcomes. In some embodiments, the data processing module can send the resulting data set to the data exploration module to determine updated quality metrics and flag any issues that remain. The steps of processing the data set by the data processing module, determining the quality metrics and flagging issues in the data set by the data exploration module, and the data processing module further processing the data set based on the updated quality metrics and flagged issues can repeat until the data processing module determines that no further processing of the data set is required.

In block 506, a feature selection module determines at least one critical feature from the processed data set for building the ML model. The critical features are features or variables whose values have a statistically significant correlation to the outcome, which is the output of the ML model. The feature selection module can identify the features and variables in the data set and determine their correlation strength to the outcome. The feature selection module can then determine one or more critical features based on the determined correlation strength of the features and variables. In some embodiments, the feature selection module can determine that the features that exceed a minimum correlation strength to the outcome are critical features. The feature selection module can list by ascending or descending order the features and variables according to their corresponding correlation strengths.

In block 508, a model selection module selects the ML model from a plurality of ML models based on the processed data set and the at least one critical feature. The model selection module can evaluate various ML model constructs and select the ML model among the different types of ML models based on the processed data set and the critical features. The ML model constructs can include different types of ML models such as, without limitation, linear regression, logistic regression, random forest, decision tree, clustering, neural network, and several different hyperparameter combinations of the same. The model selection module can also select a combination of ML models. The model selection module can also receive user input to adjust the parameters and hyperparameters. The model selection module can also train and/or validate the selected ML model using at least a portion of the processed data set and/or other imported data sets.

In block 510, a model monitoring module monitors the ML model, wherein the monitoring includes determining whether an output of the ML model exceeds a defined threshold. The model monitoring model can begin monitoring the ML model when the ML model is launched and receiving real data. The model monitoring module can pull data sets from a library of data sets for testing the performance of the ML model. The model monitoring module can further generate at least one performance indicator based on output by the ML model and comparing, by the performance indicator with a performance threshold. Performance indicators can include, for example, accuracy, precision, specificity, confusion matrix, recall, F1-score, Receiver Operating Characteristic (ROC) curve, and Area Under the Receiver Operating Characteristic (AUC-ROC) curve. Performance indicators can indicate the percentage of true positives, false positives, true negatives, false negatives, or otherwise incorrect classifications among the total ML model output. The thresholds can be default thresholds or customized by the user.

In method 500, when each module generates the described respective output, the module can automatically send the output for the next module to receive as input and automatically perform the subsequent step in method 500 using the received input. For example, after processing the data set, the data processing module can automatically send the processed data set to the feature selection module and, upon receiving the processed data set, the feature selection module can automatically commence the determining at least one critical feature from the processed data set.

The data exploration module, the data processing module, the feature selection module, the model selection module, and the model monitoring module can interconnect to form a pipeline, and the pipeline can be configured for execution by a single function call. Method 500 can further include receiving, as user input, customization of at least one class, object, and/or function and calling the customized at least one class, object, and/or function based on a reference to the customized at least one class, object, and/or function in a configuration file. A configuration file, which dictates the performance of each module, can reference a keyword associated with the customized class, object, and/or function and automatically call the customized class, object, and/or function. For example, a customized function can be automatically executed based on a reference to the customized function in the configuration file. In this aspect, any customized Python object can be imported and used by the modules.

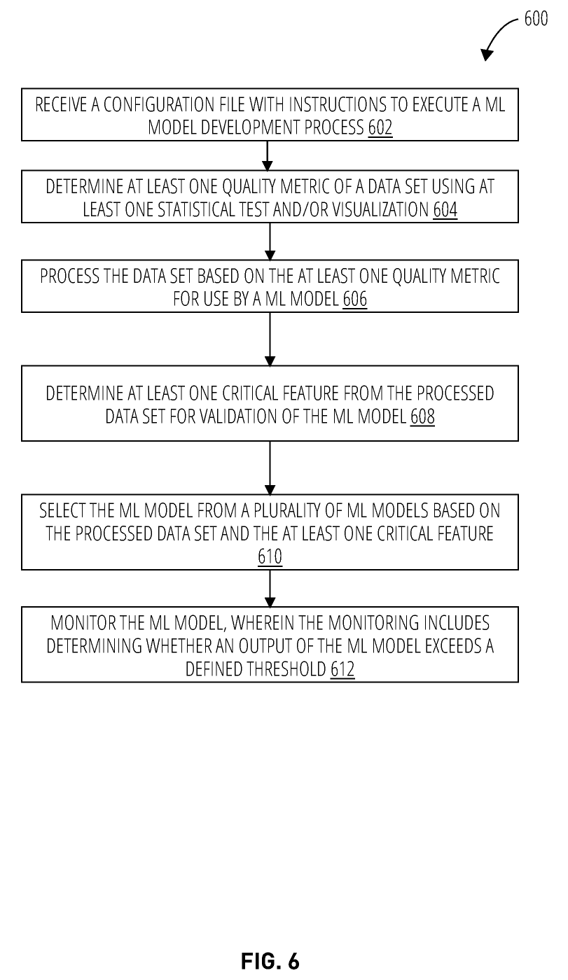

FIG. 6 is a flow chart of an example method 600 for machine learning development. Method 600 can be implemented, for example, by at least one processor according to stored instructions in memory that, when executed, cause the processor to perform the steps described. In block 602, a configuration file with instructions to execute a ML model development process is received. The configuration file includes at least one function call to execute the ML model development process. The configuration file can execute the ML model development process with a single function call. The configuration file can include at least one keyword referencing a customized Python object. The configuration file can identify a data set in a data set library for processing or the configuration file can include a data set file. The configuration file can at least one of hyperparameter adjustments, parameter adjustments, a ML model type selection, and the number of critical features to select. A customization of at least one class, object, and/or function can be received and called based on a reference to the customized class, object, and/or function. A customized function can automatically be executed based on a reference to the customized function in the configuration file.

In block 604, at least one quality metric of a data set is determined using at least one statistical test and/or at least one visualization. The data set can be real data harvested, fabricated data, or a combination thereof. The processor can retrieve stored statistical tests or a user can import statistical tests for the data exploration module to implement. The configuration file can identify which statistical tests to perform. Quality metrics can include, for example, a minimum value, maximum value, mean, mode, standard deviation, distribution, variance, percentage of data values in a category or range, and the like. The processor can also identify and flag issues in the data set that may affect the data set's viability for use in the development of the ML model, such as such as a zero value, infinity value, nonvalue, and an imbalanced data set with one or more categories that are significantly underrepresented. The processor can generate and display the determined quality metrics and flagged issues on a GUI and can generate a report including the same.

In block 606, the data set is processed based on the at least one quality metric for use by a ML model. The processor may determine, based on the received quality metrics, including any flagged issues, that the data set requires one or more corrections and/or transformations, which the processor then performs on the data set. Transformations can include, for example, log transformations, square root transformations, scalers, and binning. In examples where imbalanced outcomes in the data set is an identified issue, the processor can import at least a portion of data from one or more other data sets and combine the data with the current data set to balance the data set. In some embodiments, the processor can determine updated quality metrics and flag any issues that remain in the revised data set. The steps of processing the data set, determining the quality metrics and flagging issues in the data set, and further processing the data set based on the updated quality metrics and flagged issues can repeat until the processor determines that no further processing of the data set is required.

In block 608, at least one critical feature is determined from the processed data set for building the ML model. The critical features are features or variables whose values have a statistically significant correlation to the outcome, which is the output of the ML model. The processor can identify the features and variables in the data set and determine their correlation strength to the outcome. The processor can then determine one or more critical features based on the determined correlation strength of the features and variables. In some embodiments, critical features are the features and variables that exceed a defined minimum correlation strength to the outcome. The processor can list by ascending or descending order the features and variables according to their corresponding correlation strengths.

In block 610, the ML model is selected from a plurality of ML models based on the processed data set and the at least one critical feature. The processor can evaluate various ML model constructs and select the ML model among the different types of ML models based on the processed data set and the critical features. The ML model constructs can include different types of ML models such as, without limitation, linear regression, logistic regression, random forest, decision tree, clustering, neural network, and several different combinations of hyperparameters for the same. The processor can also select a combination of ML models. The processor can adjust the parameters and hyperparameters based on user input. The processor can also train and/or validate the selected ML model using at least a portion of the processed data set and/or other imported data sets.

In block 612, the ML model is monitored, wherein the monitoring includes determining whether an output of the ML model exceeds a defined threshold. After training and validation of the ML model, the processor launches the ML model to receive real data. The processor then monitors the launched ML model. As part of the monitoring, the processor can pull data sets from a library of data sets for testing the performance of the ML model. At least one performance indicator can be generated based on output by the ML model and the at least one performance indicator can be compared with a performance threshold. Performance indicators can include, for example, accuracy, precision, specificity, confusion matrix, recall, F1-score, Receiver Operating Characteristic (ROC) curve, and Area Under the Receiver Operating Characteristic (AUC-ROC) curve. Performance indicators can indicate the percentage of true positives, false positives, true negatives, false negatives, or otherwise incorrect classifications among the total ML model output. The thresholds can be default thresholds or customized by the user.

A subsequent step in method 600 can automatically commence when the preceding step is complete and output generated from the preceding step can be used as input for the subsequent step.

FIG. 7 illustrates an embodiment of an exemplary computer architecture 700 suitable for implementing various embodiments as previously described. In one embodiment, the computer architecture 700 may include or be implemented as part of one or more systems or devices discussed herein. For example, the computer architecture 700 includes components that can implement one or more of the computing device 102 and database 120, and any other computing device described in this application.

As used in this application, the terms “system” and “component” are intended to refer to a computer-related entity, either hardware, a combination of hardware and software, software, or software in execution, examples of which are provided by the exemplary computer architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 700 includes various common computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. The embodiments, however, are not limited to implementation by the computer architecture 1500.

As shown in FIG. 7, the computer architecture 700 includes a processor 712, a system memory 704 and a system bus 706. The processor 712 can be any of various commercially available processors or processor circuits.

The system bus 706 provides an interface for system components including, but not limited to, the system memory 704 to the processor 712. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile 708 and/or volatile 710. A basic input/output system (BIOS) can be stored in the non-volatile 708.

The computer 702 may include various types of computer-readable storage media in the form of one or more lower speed memory units, including an internal (or external) hard disk drive 730, a magnetic disk drive 716 to read from or write to a removable magnetic disk 720, and an optical disk drive 728 to read from or write to a removable optical disk 732 (e.g., a CD-ROM or DVD). The hard disk drive 730, magnetic disk drive 716 and optical disk drive 728 can be connected to system bus 706 the by an HDD interface 714, and FDD interface 718 and an optical disk drive interface 734, respectively. The HDD interface 714 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 708, and volatile 710, including an operating system 722, one or more applications 742, other program modules 724, and program data 726. In one embodiment, the one or more applications 742, other program modules 724, and program data 726 can include, for example, the various applications and/or components of the systems discussed herein.

A user can enter commands and information into the computer 702 through one or more wire/wireless input devices, for example, a keyboard 750 and a pointing device, such as a mouse 752. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 712 through an input device interface 736 that is coupled to the system bus 706 but can be connected by other interfaces such as a parallel port, IEEE 1394 serial port, a game port, a USB port, an IR interface, and so forth.

A monitor 744 or other type of display device is also connected to the system bus 706 via an interface, such as a video adapter 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory and/or storage device 758 is illustrated. The logical connections depicted include wire/wireless connectivity to a local area network 756 (LAN) and/or larger networks, for example, a wide area network 754 (WAN). Such LAN and WAN networking environments are commonplace in offices and companies, and facilitate enterprise-wide computer networks, such as intranets, all of which may connect to a global communications network, for example, the Internet.

When used in a local area network 756 networking environment, the computer 702 is connected to the local area network 756 through a wire and/or wireless communication network interface or network adapter 738. The network adapter 738 can facilitate wire and/or wireless communications to the local area network 756, which may also include a wireless access point disposed thereon for communicating with the wireless functionality of the network adapter 738.

When used in a wide area network 754 networking environment, the computer 702 can include a modem 740, or is connected to a communications server on the wide area network 754 or has other means for establishing communications over the wide area network 754, such as by way of the Internet. The modem 740, which can be internal or external and a wire and/or wireless device, connects to the system bus 706 via the input device interface 736. In a networked environment, program modules depicted relative to the computer 702, or portions thereof, can be stored in the remote memory and/or storage device 758. It will be appreciated that the network connections shown are exemplary and other means of establishing a communications link between the computers can be used.

The computer 702 is operable to communicate with wire and wireless devices or entities using the IEEE 1102 family of standards, such as wireless devices operatively disposed in wireless communication (e.g., IEEE 1102.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It is noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, e.g., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

It is further appreciated that references to specific programming languages, such as Python, are illustrative and non-limiting. It is understood that the present disclosure is not limited to a particular programming language and encompasses any programming language, including without limitation, assembly language, Ada, APL, Basic, C, C++, COBOL, dBase, Forth, Fortran, Java, Modula-2, Pascal, Prolog, REXX, Visual Basic, JavaScript and/or Python.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of "user interfaces" may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for machine learning (ML) model development, comprising:
determining, by a data exploration module, at least one quality metric of a data set using at least one statistical test and/or visualization;
processing, by a data processing module, the data set based on the at least one quality metric for use by a ML model;
determining, by a feature selection module, at least one critical feature from the processed data set for building the ML model;
selecting, by a model selection module, the ML model from a plurality of ML models based on the processed data set and the at least one critical feature; and
monitoring, by a model monitoring module, the ML model, wherein the monitoring includes determining whether an output of the ML model exceeds a defined threshold.

2. The method of claim 1, further comprising:
generating, by the model monitoring module, at least one performance indicator based on output by the ML model; and
comparing, by the model monitoring module, the at least one performance indicator with a performance threshold.

3. The method of claim 1, wherein, after processing the data set, the data processing module automatically sends the processed data set to the feature selection module, and wherein, upon receiving the processed data set, the feature selection module automatically commences the determining at least one critical feature from the processed data set.

4. The method of claim 1, wherein at least two modules of the data exploration module, the data processing module, the feature selection module, the model selection module, and the model monitoring module are chained such that an output from a first module of the two modules is automatically sent to a second module of the two modules, wherein the second module receives the output as input for the second module.

5. The method of claim 1, comprising:
receiving, as user input, customization of at least one class, object, and/or function; and
calling the customized at least one class, object, and/or function based on a reference to the customized at least one class, object, and/or function in a configuration file.

6. The method of claim 5, wherein the customized at least one class, object, and/or function comprises a customized function, wherein the customized function is automatically executed based on a reference to the customized function in the configuration file.

7. The method of claim 1, wherein the data exploration module, the data processing module, the feature selection module, the model selection module, and the model monitoring module form a pipeline that is configured for execution by a single function call.

8. A non-transitory computer-readable storage medium storing instructions for machine learning (ML) model development that when executed by a processor cause the processor to:
determine at least one quality metric of a data set using at least one statistical test;
process the data set based on the at least one quality metric for use by a ML model;
determine at least one critical feature from the processed data set for building the ML model;
select the ML model from a plurality of ML models based on the processed data set and the at least one feature; and
monitor the ML model, wherein the monitoring includes determining whether an output of the ML model exceeds a defined threshold.

9. The non-transitory computer-readable storage medium of claim 8, wherein the instructions when executed by the processor cause the processor to:
generate at least one performance indicator based on output by the ML model; and
compare the at least one performance indicator with a performance threshold.

10. The non-transitory computer-readable storage medium of claim 8, wherein the instructions when executed by the processor cause the processor to receive a configuration file, wherein the configuration file indicates the data set for processing and references at least one customized object.

11. The non-transitory computer-readable storage medium of claim 8, wherein the instructions when executed by the processor cause the processor to:
receive, as user input, customization of at least one class, object, and/or function; and
call the at least one class, object, and/or function based on a reference to the customized at least one class, object, and/or function in a configuration file.

12. The non-transitory computer-readable storage medium of claim 11, wherein the customized at least one class, object, and/or function comprises a customized function, wherein the instructions when executed by the processor cause the processor to automatically execute the customized function based on a reference to the customized function in the configuration file.

13. The non-transitory computer-readable storage medium of claim 8, wherein the instructions are configured for execution by a single function call.

14. A system for machine learning (ML) model development, comprising:
at least one processor; and
at least one memory, the memory containing:
a framework for ML model development comprising a plurality of interconnectable modules each configured to receive an input, perform at least one distinct function, and generate an output based on the input, wherein each interconnectable module can be arranged respective to the other interconnectable modules in a ML model development pipeline.

15. The system of claim 14, wherein the memory further contains a user space configured to receive as user input customization of at least one class, object, and/or function, wherein the framework is configured to automatically tag the at least one class, object, and/or function and embed the at least one class, object, and/or function in the ML model development pipeline.

16. The system of claim 15, wherein the customized at least one class, object, and/or function comprises a customized function, wherein the customized function is executed in the ML model development pipeline based on a reference to the customized function in a configuration file.

17. The system of claim 14, wherein the plurality of interconnectable modules is configured to provide a visual representation of the generated output via a graphical user interface.

18. The system of claim 14, wherein the ML model development pipeline is configured for execution by a single call function.

19. The system of claim 14, wherein two interconnectable modules of the plurality of interconnectable modules are chained such that an output from a first interconnectable module is automatically sent to a second interconnectable module, wherein the second module receives the output as input for the second module.

20. The system of claim 14, wherein one interconnectable module of the plurality of interconnectable modules is configured for selecting a ML model, wherein the framework is configured for generating a report based on output of the ML model.
